(19) United States
(12) Patent Application Publication
(10) Pub. No.: US 2025/0020177 A1
(43) Pub. Date: Jan. 16, 2025

(54) CALIPER BRAKE

(71) Applicant: HL MANDO CORPORATION, Gyeonggi-do (KR)

(72) Inventor: Yunkwang KIM, Gyeonggi-do (KR)

(21) Appl. No.: 18/654,862

(22) Filed: May 3, 2024

(30) Foreign Application Priority Data
Jul. 13, 2023 (KR) 10-2023-0091021

(51) Int. Cl. F16D 55/2265; F16D 55/00; F16D 55/227; F16D 65/00; F16D 65/18

(52) U.S. Cl. CPC F16D 55/22655; F16D 55/227; F16D 65/0025; F16D 65/0056; F16D 65/0068; F16D 65/0087; F16D 2055/0008; F16D 2055/0016; F16D 2055/007; F16D 65/18

(57) ABSTRACT

A caliper brake may include a carrier fixedly installed on a vehicle body and including a guide hole, a guide rod slidably inserted in the guide hole of the carrier, and a caliper housing coupled to the guide rod to be movable together with the guide rod with respect to the carrier. An end portion of the guide rod may be fixedly coupled to a coupling hole formed at the caliper housing, and the guide hole is formed in a protruding part of the carrier protruding toward an inside of the vehicle body.

### CROSS-REFERENCE TO RELATED APPLICATION

This application claims the benefit of and priority to Korean Patent Application No. 10-2023-0091021, filed on Jul. 13, 2023 in the Korean Intellectual Property Office, the disclosure of which is incorporated herein by reference in its entirety.

### BACKGROUND

### 1. Field

The present disclosure generally relates to a caliper brake. Specifically, some embodiments of the present disclosure relate to a caliper brake with improved structural stability and operational reliability.

### 2. Description of the Related Art

Brake systems for performing braking are necessarily installed in vehicles, and various types of brake systems have been developed for safety of drivers and passengers.

The conventional braking system mainly uses a hydraulic mechanism for supplying a hydraulic pressure necessary for braking to a wheel cylinder using a mechanically connected booster when a driver steps on a brake pedal.

And, an electromechanical brake (EMB) system may perform braking of a vehicle by receiving a driver's braking intention as an electrical signal and operating an electric device such as a motor on the basis of the electrical signal.

In such an EMB, since a motor for driving and an actuator for converting a rotational force of the motor into linear motion may be mounted at or around a side of a wheel cylinder of a caliper housing, a weight of a brake assembly of the EMB may be heavier than a weight of the conventional hydraulic type caliper brake, and the center of gravity of the EMB may be shifted to the inside of a vehicle body, and therefore a tilting phenomenon in which a side of the actuator sags may occur.

### SUMMARY

It is an aspect of the present disclosure to provide a caliper brake in which a contact surface between a guide rod and a guide hole is secured to prevent a tilting phenomenon of a caliper housing.

It is another aspect of the present disclosure to provide a caliper brake with improved structural and operational stability.

It is still another aspect of the present disclosure to provide a caliper brake with improved assemblability and mountability.

It is yet another aspect of the present disclosure to provide a caliper brake with improved performance and operational reliability.

It is yet another aspect of the present disclosure to provide a caliper brake of which maintenance is easy. In accordance with one aspect of the present disclosure, a caliper brake includes a carrier fixedly installed on a vehicle body and including a guide hole, a guide rod slidably inserted into the guide hole, and a caliper housing coupled to the guide rod to be provided to move with respect to the carrier, wherein an end portion of one side of the guide rod is provided to be coupled to the coupling hole provided in the caliper housing, and the guide hole is formed inside the carrier that includes a protruding part formed to extend and protrude to an inside of the vehicle body.

The carrier may further include a main beam in which a knuckle hole coupled to the vehicle body is formed and a pair of guide beams provided on both sides of the main beam, wherein the protruding part may be formed to extend and protrude from each of the guide beams to the inside of the vehicle body.

At least a part of a contact area in which an inner wall of the guide hole is in contact with an outer circumferential surface of the guide rod may be positioned further inside the vehicle body than an inner end portion of the main beam.

The caliper brake may further include a boot provided between an outer circumferential surface of the guide rod and an inner opening of the guide hole.

The guide hole may include a boot coupling part to which the boot is fastened The boot may be provided to surround the outer circumferential surface of the guide rod, and the boot coupling part may be formed to be recessed in an inner circumferential surface of the guide hole in a circumferential direction.

The boot coupling part may include a coupling groove formed in an inner side surface in the circumferential direction, and the boot may include an outer protrusion which is formed to protrude from an outer circumferential surface of the boot of which at least a part is inserted into and fastened to the coupling groove.

The boot may further include a flange part formed to protrude outward from an inner end portion of the boot in a circumferential direction to seal an inner opening of the boot coupling part.

An inner diameter of at least a part of an inner circumferential surface of the boot may be smaller than or equal to a diameter of the guide rod.

The boot may include at least one inner protrusion formed to protrude inward from an inner circumferential surface of the boot in a circumferential direction.

The guide hole may be formed to pass through the carrier in an axial direction.

The caliper brake may further include a stopper member sealing an outer opening of the guide hole.

The guide rod may include a fastening part inserted into the coupling hole and the fastening part and the coupling hole are screw-coupled.

The fastening part may include a stopper formed to protrude outward from the outer circumferential surface of the fastening part from the fastening part to be in contact with an outer surface of the caliper housing.

The stopper may include a coupling surface of which at least a part is provided as a flat surface to which a tool configured to rotate the guide rod is coupled.

In accordance with another aspect of the present disclosure, a caliper brake includes a carrier fixedly installed on a vehicle body and including a guide hole formed to pass through the carrier in an axial direction, a guide rod slidably inserted into the guide hole, and a caliper housing coupled to the guide rod to move with respect to the carrier, wherein an inner opening of the guide hole is sealed by a boot interposed between an outer circumferential surface of the guide rod and an inner circumferential surface of the guide hole, and an outer opening of the guide hole is sealed by a stopper member.

An end portion of one side of the guide rod may be provided to be coupled to a coupling hole provided in the caliper housing, and the guide hole is formed inside the carrier that includes a protruding part formed to extend and protrude to an inside of the vehicle body.

The carrier may include a main beam coupled to the vehicle body, and at least a part of a contact area in which an inner wall of the guide hole is in contact with the outer circumferential surface of the guide rod may be positioned further inside the vehicle body than an inner end portion of the main beam.

The guide hole may include a boot coupling part formed to be recessed in an inner circumferential surface of the inner opening, and at least a part of the boot may be inserted into and fastened to the boot coupling part.

The boot coupling part may include a coupling groove formed to be recessed in the inner side surface of the boot coupling part in a circumferential direction, and the boot may include an outer protrusion formed to protrude from an outer circumferential surface of the boot, wherein at least a part of the outer protrusion is inserted into and fastened to the coupling groove.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a perspective view illustrating a caliper brake according to an embodiment of the present disclosure;

FIG. 2 is a side view illustrating a caliper brake according to an embodiment of the present disclosure;

FIG. 3 is an exploded perspective view illustrating a caliper brake according to an embodiment of the present disclosure;

FIG. 4 is a cross-sectional view illustrating a caliper brake according to an embodiment of the present disclosure;

FIG. 5 is a perspective view illustrating a guide rod according to an embodiment of the present disclosure;

FIG. 6 is a cutaway perspective view illustrating a boot according to an embodiment of the present disclosure; and

FIG. 7 is a front view illustrating a caliper brake in a state in which a tool fastening part for coupling or separating of a guide rod is exposed outside the caliper brake according to an embodiment of the present disclosure.

### DETAILED DESCRIPTION

Hereinafter, embodiments of the present disclosure will be described in detail with reference to the accompanying drawings. The following embodiments are to provide the spirit of the present disclosure to those skilled in the art. The present disclosure is not limited to the embodiments disclosed herein and may be implemented in different forms. In the drawings, portions which are not related to the description may be omitted for clarifying the present disclosure, and sizes of components may be exaggerated for facilitating understanding of the present disclosure.

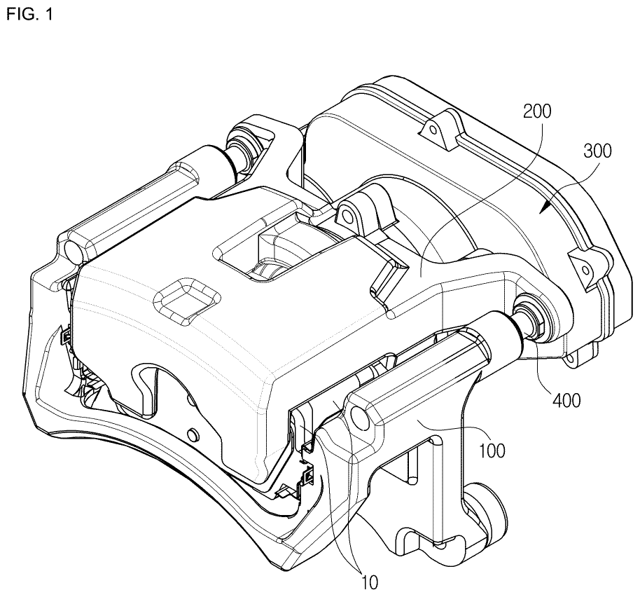

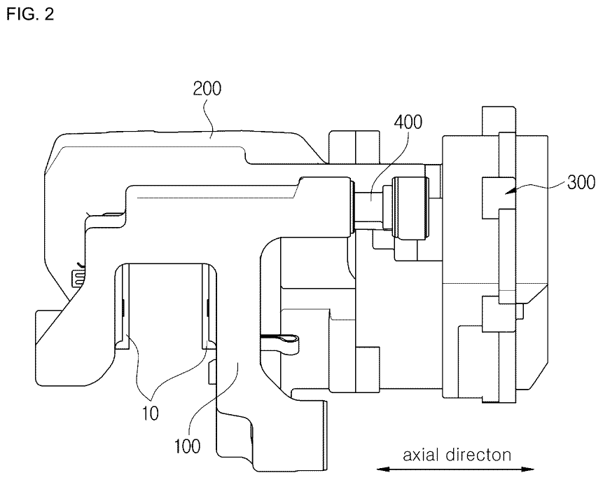

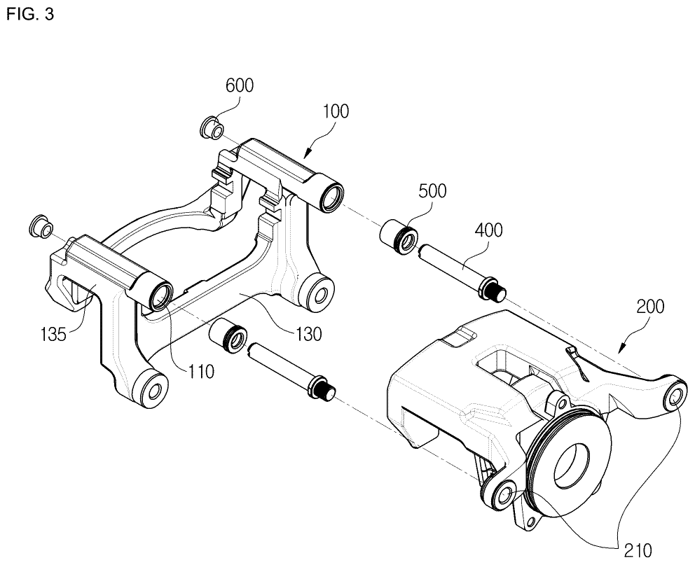

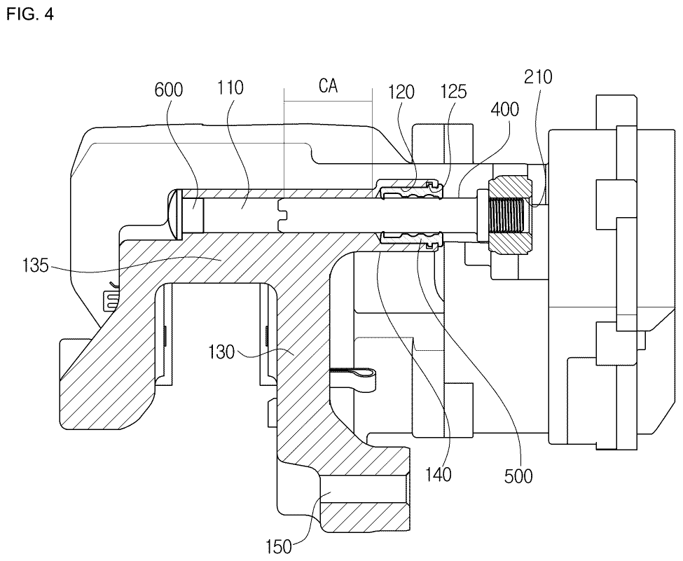

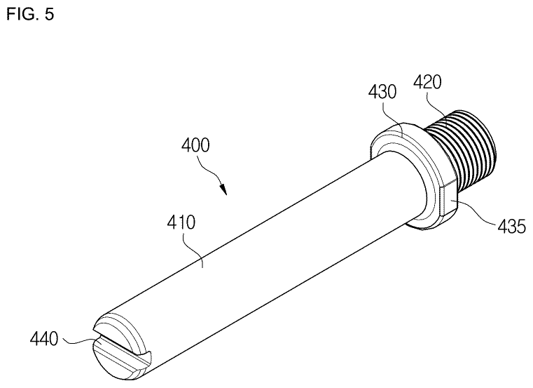

FIG. 1 is a perspective view illustrating a caliper brake according toc. FIG. 2 is a side view illustrating a caliper brake according to an embodiment of the present disclosure. FIG. 3 is an exploded perspective view illustrating a caliper brake according to an embodiment of the present disclosure. FIG. 4 is a cross-sectional view illustrating a caliper brake according to an embodiment of the present disclosure. FIG. 5 is a perspective view illustrating a guide rod according to an embodiment of the present disclosure.

Referring to FIGS. 1 to 5, a caliper brake according to the present embodiment may include a pair of pad plates 10, a carrier 100, a guide rod 400, a caliper housing 200. a brake actuator 300, and a boot 500. The pad plates 10 may be configured to press both side surfaces of a disc configured to be rotatable with a wheel. In the carrier 100, the pair of pad plates 10 are supported to be movable forward or backward and a guide hole 110 is formed. The guide rod 400 is inserted into and slidably coupled to the guide hole 110. The caliper housing 200 is coupled to the guide rod 400 to slide to the carrier 100. The brake actuator 300 is configured to provide a driving force to press the pair of pad plates 10. The boot 500 is configured to seal between an outer circumferential surface of the guide rod 400 and an opening or end of the guide hole 110.

The disc rotates together with the wheel, and at least a part of one side of an outer circumference of the disc may be inserted or rotatably disposed inside the carrier 100 coupled to a vehicle body. The carrier 100 may be fixedly installed to or on the vehicle body and support the pair of pad plates 10 so that the pair of pad plates 10 can move forward or backward. Referring to FIGS. 3 and 4, the carrier 100 may include a main beam 130, a pair of guide beams 135, and a protruding part 140. The main beam 130 may have a knuckle hole 150 coupled to the vehicle body. The main beam 130 may be arranged in the form of a beam extending to connect between a pair of knuckle holes 150. The pair of guide beams 135 may be provided on both sides of the main beam 130. The protruding part 140 may protrude from each of the guide beams 135 toward the inside of the vehicle body.

The main beam 130 may be fixed to the vehicle body using a fastener, for example, but not limited to, a mounting bolt fastened to the knuckle hole 150, and a sliding groove is formed in or at each of both sides of the main beam 130 and a protruding part of each of the pad plates 10 inserted into the sliding groove may be formed in the guide beam 135. The protruding part 140 may be formed at or in an inner end portion of the guide beam 135 to extend and protrude toward the inside of the vehicle body. As the protruding part 140 extends and protrudes toward the inside of the vehicle body, a tilting phenomenon due to a biased center of gravity during braking can be prevented, which will be described in detail below.

The guide hole 110 may be formed in an axial direction of the disc in the guide beam 135 to pass through the guide beam 135 and the protruding part 140 of the carrier 100. The guide rod 400, which will be described below, may be slidably inserted into the guide hole 110, and the caliper housing 200 can stably move linearly with respect to the carrier 100 due to the structures of the guide hole 110 and the guide rod 400.

The caliper housing 200 may further include a cylinder and the actuator 300. A pressing member such as a piston configured to press at least one of the pad plates 10 is provided in the cylinder of the caliper housing 200, and the actuator 300 configured to operate or move the pressing member may be supported by the caliper housing 200. The actuator 300 may include, for example, but not limited to, one or more of a motor configured to provide a rotational driving force, a reduction gear unit configured to transmit the rotational driving force of the motor, and a pressing part configured to convert the rotational driving force into linear motion to press the piston in response to the rotational driving force transferred from the reduction gear unit.

The caliper housing 200 may be coupled to, or have, the guide rod 400 to be slidable with respect to the carrier 100, and a coupling hole 210 may be formed to be recessed in or pass through the caliper housing 200 in the axial direction of the disc to be firmly coupled to the guide rod 400.

An inner end portion of the guide rod 400 may be coupled to the caliper housing 200 to be slidably inserted into the guide hole 110. Optionally, the carrier 100 and the caliper housing 200 may have a pair of guide holes 110 and a pair of guide rods 400 provided symmetrically, respectively.

A fastening part or faster part 420 may be provided or formed at or on an end portion of the guide rod 400 (e.g. an inner end portion of the guide rod 400 coupled to the caliper housing 200), and the fastening part 420 may be directly coupled to the coupling hole 210 provided in the caliper housing 200. The fastening part 420 and the coupling hole 210 may be screw-coupled so that the guide rod 400 and the caliper housing 200 can be firmly coupled, although not required. To this end, screw threads may be formed on an outer circumferential surface of the fastening part 420 of the guide rod 400 and an inner circumferential surface of the coupling hole 210 of the caliper housing 200. Alternatively, the guide rod 400 and the caliper housing 200 may be coupled to each other by any coupling means such as press-fit coupling structures in which the fastening part 420 is press-fitted into the coupling hole 210.

Meanwhile, a load of the caliper housing 200 and the actuator 300 is supported by a contact area CA where the outer circumferential surface of the guide rod 400 can be in direct contact with an inner wall of the guide hole 110.

Generally, the actuator 300 is mounted to or in the caliper housing 200 inside the vehicle body. Accordingly, the center of gravity of the caliper housing 200 and the actuator 300 is biased to the inside of the vehicle body, and accordingly, a tilting phenomenon in which a connection portion between the caliper housing 200 and the actuator 300 is sagged downward from the actuator 300 is generated. Since the tilting phenomenon may degrade the structural stability of the brake system and affect braking performance and product durability, it is required to suppress or prevent the tilting phenomenon.

Accordingly, in the caliper brake according to the present embodiment, the contact area CA may expand to the inside of the vehicle body so that the center of gravity of the connection portion between the caliper housing 200 and the brake actuator 300 is positioned in the contact area CA to stably support the caliper housing 200 and the actuator 300 and suppress or prevent the tilting phenomenon due to the biased center of gravity.

Specifically, at least a part of the contact area CA in which an inner wall of the guide hole 110 is in contact with the outer circumferential surface of the guide rod 400 may be formed or provided to be positioned further inside the vehicle body than an inner end portion of the main beam 130. Accordingly, since the center of gravity of the connection portion between the caliper housing 200 and the actuator 300 is positioned in the contact area CA, structural stability can be improved or achieved. To this end, as described above, the protruding part 140 in which the guide hole 110 is formed may protrude and extend to the inside of the vehicle body from the inner end portion of the guide beam 135.

The guide rod 400 will be described in more detail with reference to FIG. 5.

The guide rod 400 includes a rod body 410 inserted into and configured to be slidable in the guide hole 110. The rod body 410 may be formed in a rod shape having a predetermined length. The fastening part 420 is provided at or in an end portion of one side of the guide rod 400 to be inserted into and fixedly coupled to the coupling hole 210. As described above, as the screw thread may be provided on the outer circumferential surface of the fastening part 420, the fastening part 420 may be screw-coupled to the coupling hole 210. A stopper 430 formed to protrude outward from the outer circumferential surface of the guide rod 400 (for instance, the outer circumferential surface of the fastening part 420) may be provided in contact with an outer surface of a peripheral portion of the caliper housing 200 in which the coupling hole 210 is formed. The stopper 430 may be provided on a portion of the rod body 410 outside the fastening part 420 to be in contact with an outer surface of the caliper housing 200 when the fastening part 420 is screw-coupled to the coupling hole 210 of the housing 200, thereby limiting a fastening stroke so as to prevent damage to a component due to excessive fastening between the guide rod 400 and the coupling hole 210 and improving assembly quality.

A coupling surface 435 may be provided on an outer circumferential surface of the stopper 430. At least a part of the coupling surface 435 may have a flat surface to be coupled to a tool for rotating the guide rod 400. And, the coupling surface 435 may be differently angled from the outer circumferential surface of the stopper 430. Because the tool for rotating the guide rod 400, such as a spanner, can be in contact with and supported by the coupling surface 435, as the tool can rotate the guide rod 400, the coupling surface 435 can improve the assemblability of the guide rod 400 and can make the maintenance easy. Additionally or optionally, a tool fastening part or structure 440 to which the tool configured to rotate the guide rod 400 can be coupled may be provided at or in an end portion of the other side of the guide rod 400.

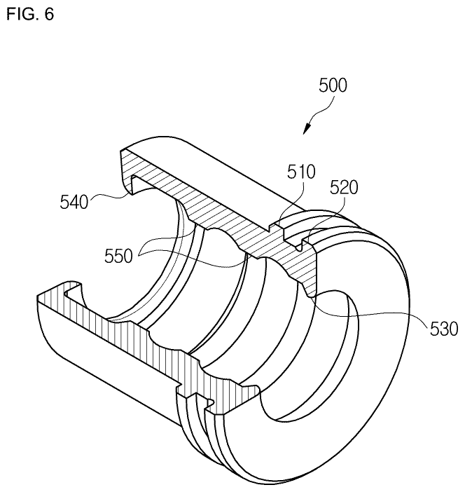

FIG. 6 is a perspective cross-sectional view illustrating a boot according to an embodiment of the present disclosure.

Referring to FIGS. 1 to 6, the boot 500 may be disposed between the guide rod 400 and the guide hole 110. The boot 500 may be configured to seal between the outer circumferential surface of the guide rod 400 and an inner circumferential surface of the guide hole 110. For example, the boot 500 may be provided in a cylindrical shape with a hollow passing therethrough in an axial direction of the disc and interposed between the outer circumferential surface of the guide rod 400 and an inner opening of the guide hole 110 to seal the inner opening of the guide hole 110. Accordingly, foreign substance or matter or moisture can be prevented from entering or flowing in through the inner opening of the guide hole 110, and a lubricant which fills the guide hole 110 can be prevented from leaking to the outside of the guide hole 110.

The boot 500 may be provided to surround or cover the outer circumferential surface of the guide rod 400 and fastened to and supported in the guide hole 110. To this end, the guide hole 110 may include a boot coupling part 120 recessed from the inner circumferential surface of the guide hole 110 in a circumferential direction. The boot coupling part 120 is formed at a part of the inner circumferential surface of the guide hole 110 where at least a part of the boot 500 is inserted and mounted. As an example, the boot coupling part 120 may be provided to have an inner diameter greater than an inner diameter of the inner circumferential surface of the guide hole 110 at a side of the inner opening of the guide hole 110 into which the guide rod 400 is inserted. Accordingly, during the installation of the boot 500, first, the boot 500 may be mounted to surround the outer circumferential surface of the guide rod 400, and then the guide rod 400 and the boot 500 may be inserted into and installed in the guide hole 110.

The boot coupling part 120 may further include a coupling groove 125 recessed from an inner side surface of the boot coupling part 120 in a circumferential direction to more stably support the boot 500. In addition, an outer protrusion 510 protrudes from an outer circumferential surface of the boot 500 in a circumferential direction, and as at least a part of the outer protrusion 510 of the boot 500 is inserted and fastened into the coupling groove 125 of the carrier 100, the boot 500 may be fastened to and supported in the guide hole 110.

A flange part 520 may be configured to seal an inner opening of the boot coupling part 120 and may be provided at or on an inner end portion of the boot 500. The flange part 520 may be formed to protrude outward from an outer circumferential surface of the inner end portion of the boot 500 in the circumferential direction, and as the flange part 520 may be in close contact with a portion around the inner opening of the boot coupling part 120 on an outer surface of the carrier 100, the entry or inflow of foreign substance or matter can be more effectively suppressed or prevented.

An inner diameter of at least a part of an inner circumferential surface of the boot 500 may be smaller than or equal to an inner diameter of the guide rod 400. Specifically, the inner diameters of a front end portion 530 and a rear end portion 540 of the boot 500 in an insertion direction of the guide rod 400 may be smaller than or equal to a diameter of the guide rod 400. Accordingly, when the guide rod 400 passes through and is coupled to the front end portion 530 and the rear end portion 540, the shapes of the front end portion 530 and the rear end portion 540 are deformed so that the inner circumferential surfaces of the front end portion 530 and the rear end portion 540 may be in close contact with the outer circumferential surface of the guide rod 400 to prevent foreign substance or matter from entering or inflowing between the guide rod 400 and the boot 500.

Meanwhile, an inner diameter of an inner circumferential surface of a portion of the boot 500 between the front end portion 530 and the rear end portion 540 may be greater than the outer diameter of the guide rod 400. Accordingly, a lubricant injected into the guide hole 110 may be accommodated in a space formed between the inner circumferential surface of the boot 500 and the outer circumferential surface of the guide rod 400. As the lubricant is applied to the space between the inner circumferential surface of the boot 500 and the outer circumferential surface of the guide rod 400, the friction between the boot 500 and the guide rod 400 may be reduced and generation of noise or vibration may be suppressed during the slide movement of the guide rod 400. In addition, the damage to the boot 500 due to the friction can be prevented.

The boot 500 includes one or more inner protrusions 550 protruding inward from the inner circumferential surface of the boot 500 in the circumferential direction. The inner protrusion 550 may be provided as one single protrusion 550 or a plurality of inner protrusions 550 on the inner circumferential surface of the boot 500. An inner diameter of the inner protrusion 550 may be smaller than or equal to the outer diameter of the guide rod 400 and greater than the inner diameter of each of the front end portion 530 and the rear end portion 540. Accordingly, the inner protrusion 550 of the boot 500 is in contact with an outer surface of the guide rod 400 to prevent foreign substance or matter from entering or inflowing and allow the boot 500 to be easily mounted on the guide rod 400.

A stopper member 600 is provided to close and seal an outer opening of the guide hole 110 (e.g. an outer end of the guide hole 110). The stopper member 600 may include an insertion part having a outer diameter identical to or greater than an inner diameter of the outer opening of the guide hole 110 so that the insertion part of the stopper member 600 can be inserted into and seal the guide hole 110. Accordingly, foreign substance or matter or moisture can be prevented from entering or inflowing through the outer opening of the guide hole 110, and the lubricant filling the inside space of the guide hole 110 can be prevented from leaking to the outside of the guide hole 110. As described above, the inner opening or end of the guide hole 110 may be sealed by the boot 500, and the outer opening or end of the guide hole 110 may be sealed by the stopper member 600 to prevent durability degradation due to the inflow or entry of foreign substance or matter or lubricant leakage and achieve operational stability.

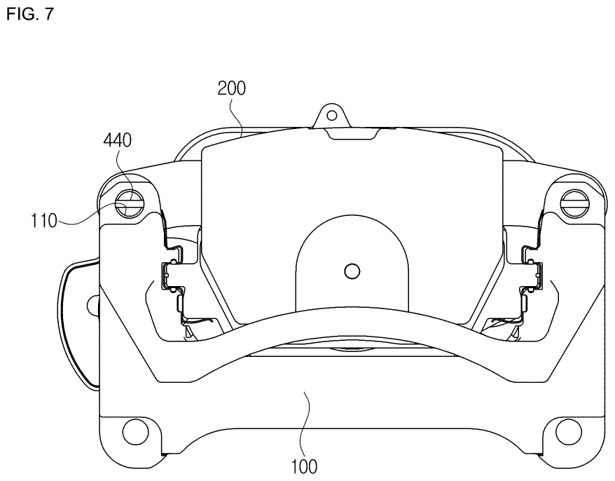

FIG. 7 is a front view illustrating a caliper brake in a state in which a tool fastening part for coupling or separating of a guide rod is exposed to an outside of the caliper brake according to an embodiment of the present disclosure.

Hereinafter, a method of manufacturing or assembling a caliper brake will be described according to the present embodiment. First, a method of mounting the caliper brake will be described according to the present embodiment.

The carrier 100 installed to allow the pair of pad plates 10 to move forward or backward is fixed to a vehicle (e.g. a vehicle body) so that a part of an outer circumferential surface of the disc is rotatably positioned between the pair of pad plates 10.

When the carrier 100 is fixed to the vehicle, the end portion of the other side of the guide rod 400 in which the fastening part 420 is provided is inserted into an end portion of one side of the guide hole 110 of the carrier 100. When the guide rod 400 is inserted into the guide hole 110, the caliper housing 200 is positioned so that the fastening part 420 of the guide rod 400 faces the coupling hole 210 of the caliper housing 200. When the caliper housing 200 is positioned so that the fastening part 420 faces the coupling hole 210 of the caliper housing 200, a finger part of the caliper housing 200 is disposed outside an outer pad plate 10, and the cylinder of the caliper housing 200 is disposed outside an inner pad plate 10.

When the caliper housing 200 is positioned, the fastening part 420 is directly inserted into or coupled to the coupling hole 210 of the caliper housing 200. The fastening part 420 may be screw-coupled to the coupling hole 210, and to this end, the guide rod 400 may be rotated to couple the screw thread of the outer circumferential surface of the fastening part 420 and a screw thread of the inner circumferential surface of the coupling hole 210. The tool fastening part 440 may be used to couple the fastening part 420 to the coupling hole 210. To this end, first, the tool is installed using the outer opening of the guide hole 110 formed to pass through the carrier 100. Since the guide hole 110 is formed to pass through the carrier 100, the tool fastening part 440 provided on an end portion of the guide rod 400 is exposed to the outside of the carrier 100 through the outer opening which is an opposite side of the inner opening into which the guide rod 400 is inserted. In FIG. 7, a shape of the tool fastening part 440 exposed to the outside of the carrier 100 as described above is illustrated.

The tool inserted through the outer opening is coupled to the tool fastening part 440 of the guide rod 400. As an example, the tool fastening part 440 have a slotted flat surface and may have a groove having a straight shape, and a flathead screwdriver may be inserted through a through hole to be coupled to the groove having the straight shape. Then, the inserted tool is rotated to screw the fastening part 420 to the coupling hole 210. When the tool coupled to the tool fastening part 440 is rotated, the guide rod 400 is also rotated with the tool fastening part 440, and the screw thread of the outer circumferential surface of the fastening part 420 may be coupled to the screw thread of the inner circumferential surface of the coupling hole 210 by the rotation of the guide rod 400. When the fastening part 420 is coupled to the coupling hole 210, an operator may rotate the tool until the stopper 430 of the fastening part 420 comes into contact with the caliper housing 200 to generate a certain torque. After the fastening part 420 is coupled to the coupling hole 210, the stopper member 600 may be coupled to the through hole of the open guide hole 110 to seal the outer opening, and thus foreign matter can be prevented from flowing into the guide hole 110 from the outside of the guide hole 110.

Meanwhile, in the present embodiment, the coupling surface 435 may also be used to couple the fastening part 420 to the coupling hole 210. To this end, the tool is coupled to the coupling surface 435 provided on at least a part of the outer circumferential surface of the stopper 430 protruding outward from the outer circumferential surface of the guide rod 400 to be in contact with a surface of the caliper housing 200 in which the coupling hole 210 is formed. The coupling surface 435 may be provided as at least a pair of flat surfaces facing each other. As described above, the tool such as a spanner may be coupled to the coupling surface 435 provided as at least the pair of flat surfaces facing each other.

Then, the coupled tool is rotated to screw the fastening part 420 to the coupling hole 210. When the tool coupled to the coupling surface 435 is rotated, the guide rod 400 is also rotated with the coupling surface 435, and the screw thread of the outer circumferential surface of the fastening part 420 may be coupled to the screw thread of the inner circumferential surface of the coupling hole 210 by the rotation of the guide rod 400. The operator may rotate the tool until the stopper 430 of the fastening part 420 comes into contact with the surface of the caliper housing 200 to generate a certain torque when the fastening part 420 is coupled to the coupling hole 210.

Hereinafter, a method of removing or disassembling the caliper brake for maintenance will be described according to the present embodiment.

The method of removing or disassembling the caliper brake may be performed in a reverse order of the method of mounting the caliper brake described above.

When the caliper brake is removed or disassembled, only the caliper housing 200 may be separated for an operation such as replacement of the pad plate 10. In order to separate the caliper housing 200, the fastening part 420 is separated from the coupling hole 210 of the caliper housing 200, and the caliper housing 200 is removed. In this case, in order to separate the fastening part 420 from the coupling hole 210, the tool fastening part 440 may be used like when the fastening part 420 and the coupling hole 210 are coupled. To this end, first, the stopper member 600 coupled to the outer opening of the guide hole 110 formed to pass through the carrier 100 is separated. As the stopper member 600 is separated to open the outer opening, the tool fastening part 440 of the guide rod 400 inserted into the guide hole 110 is exposed to the outside.

After the stopper member 600 is separated or removed from the carrier 100, the tool is inserted through the outer opening of the guide hole 110. The tool inserted through the outer opening of the guide hole 110 is coupled to the tool fastening part 440 of the guide rod 400 and rotated to separate or remove the fastening part 420, screw-coupled to the coupling hole 210, from the guide hole 119 of the carrier 100.

In addition, the coupling surface 435 may also be used to remove or separate the fastening part 420 from the coupling hole 210. To this end, the tool is coupled to the coupling surface 435 provided on at least a part of the outer circumferential surface of the stopper 430 protruding outward from the outer circumferential surface of the guide rod 400 to be in contact with the surface of the caliper housing 200 in which the coupling hole 210 is formed. As described above, the coupling surface 435 may be provided as at least the pair of flat surfaces facing each other, and the coupling surface 435 may be coupled to the tool such as a spanner. Then, the coupled tool is rotated to separate the fastening part 420 screw-coupled to the coupling hole 210.

In a caliper brake according to the present embodiment, a tilting phenomenon of a caliper housing can be prevented by securing a contact surface between a guide rod and a guide hole.

Structural and operational stability of a caliper brake can be improved according to the present embodiment.

The assemblability and mountability of a caliper brake can be improved according to the present embodiment.

The performance and operational reliability of a caliper brake can be improved according to the present embodiment.

The maintenance of a caliper brake can be easy according to the present embodiment.

What is claimed is:

1. A caliper brake comprising:
a carrier including a guide hole;
a guide rod slidably inserted in the guide hole of the carrier; and
a caliper housing fixed to the guide rod to be movable together with the guide rod with respect to the carrier,
wherein an end portion of the guide rod is fixedly coupled to a coupling hole formed at the caliper housing, and
the guide hole is formed in a protruding part of the carrier protruding toward a vehicle body.

2. The caliper brake of claim 1, wherein the carrier further includes:
a main beam having a knuckle hole to be coupled to the vehicle body; and
a pair of guide beams provided on both sides of the main beam,
wherein the protruding part of the carrier is formed to extend and protrude from each of the guide beams toward the vehicle body.

3. The caliper brake of claim 2, wherein at least a part of an area of an inner wall of the guide hole with which an outer circumferential surface of the guide rod is contactable by slide movement of the guide rod is positioned further inside the vehicle body than an end portion of the main beam.

4. The caliper brake of claim 1, further comprising a boot provided between an outer circumferential surface of the guide rod fixed to the caliper housing and an inner surface of the guide hole of the carrier.

5. The caliper brake of claim 4, wherein the guide hole of the carrier has a boot coupling part to which the boot is coupled.

6. The caliper brake of claim 5, wherein:
the boot covers at least a part of the outer circumferential surface of the guide rod; and
the boot coupling part is formed to be recessed from an inner circumferential surface of the guide hole of the carrier.

7. The caliper brake of claim 6, wherein the boot includes an outer protrusion protruding from an outer circumferential surface of the boot, wherein at least a part of the outer protrusion of the boot is inserted in a coupling groove formed on an inner surface of the boot coupling part of the guide hole of the carrier.

8. The caliper brake of claim 7, wherein the boot further includes a flange part protruding outward from an end portion of the boot to seal an opening of the boot coupling part of the guide hole of the carrier.

9. The caliper brake of claim 6, wherein an inner diameter of at least a part of an inner circumferential surface of the boot is smaller than or equal to an outer diameter of the guide rod.

10. The caliper brake of claim 6, wherein the boot includes at least one inner protrusion protruding inward from an inner circumferential surface of the boot.

11. The caliper brake of claim 1, wherein the guide hole is formed to pass through the carrier in an axial direction of the caliper brake.

12. The caliper brake of claim 11, further comprising a stopper member covering an opening of the guide hole which is formed opposite to another opening of the guide hole in which the guide rod is inserted.

13. The caliper brake of claim 11, wherein:
the guide rod includes a screw part inserted in the coupling hole of the caliper housing; and
the screw part of the guide rod and the coupling hole of the caliper housing are screw-coupled to each other.

14. The caliper brake of claim 13, wherein the guide rod includes a stopper protruding outward from the outer circumferential surface of the guide rod such that the stopper of the guide rod is disposed to contact an outer surface of the caliper housing.

15. The caliper brake of claim 14, wherein a flat surface is formed on at least a part of an outer circumferential surface of the stopper so that a tool configured to rotate the guide rod is coupled to the flat surface of the stopper.

16. A caliper brake comprising:
a carrier including a guide hole passing through at least a part of the carrier in an axial direction of the caliper brake;
a guide rod slidably inserted in the guide hole of the carrier;
a caliper housing fixed to the guide rod to be movable together with the guide rod with respect to the carrier;
a boot coupled to one opening of the guide hole of the carrier and disposed between an outer circumferential surface of the guide rod and an inner circumferential surface of the guide hole of the carrier; and
a stopper member covering an other opening of the guide hole of the carrier.

17. The caliper brake of claim 16, wherein:
an end portion of the guide rod is fixedly coupled to a coupling hole of the caliper housing; and
the guide hole is formed in a protruding part of the carrier protruding toward an inside of a vehicle body.

18. The caliper brake of claim 17, wherein:
the carrier includes a main beam coupled to the vehicle body; and
at least a part of an area of an inner wall of the guide hole with which the outer circumferential surface of the guide rod is contactable by slide movement of the guide rod is positioned further inside the vehicle body than an end portion of the main beam.

19. The caliper brake of claim 17, wherein at least a part of the boot is inserted in a boot coupling part recessed from an inner circumferential surface of the guide hole.

20. The caliper brake of claim 19, wherein the boot includes an outer protrusion protruding from an outer circumferential surface of the boot, wherein at least a part of the outer protrusion of the boot is inserted in a coupling groove formed on an inner surface of the boot coupling part of the guide hole of the carrier.
